(19) United States
(12) Patent Application Publication
(10) Pub. No.: US 2015/0032599 A1
(43) Pub. Date: Jan. 29, 2015

(54) COMPUTER-BASED METHOD FOR SORTING PAYMENT SYSTEMS

(71) Applicant: Xsolla ( USA) Inc., Sherman Oaks, CA (US)

(72) Inventor: Aleksandr Agapitov, Sherman Oaks, CA (US)

(73) Assignee: Xsolla ( USA) Inc., Sherman oaks, CA (US)

(21) Appl. No.: 13/948,824

(22) Filed: Jul. 23, 2013

(51) Int. Cl. G06Q 20/22; G06Q 20/10

(52) U.S. Cl. CPC G06Q 20/227; G06Q 20/10
USPC 705/39

(57) ABSTRACT

A computer-based method for sorting payment systems. The computer-based method may comprise the steps of: providing an electronic data processing unit; obtaining one or more parameters of a user by said one or more applications; creating one or more payment systems groups; prioritizing the payment systems groups by the application; populating at least one of the payment systems groups with one or more payment systems based upon the parameters; sorting the payment systems within one the payment systems groups to create a sorted payment system; adding the sorted payment systems to a list; and displaying the list to the user.

### FIELD OF THE INVENTION

The present invention generally relates to a computer-based method for sorting payment systems, and more particularly, the invention relates to a computer-based method for grouping and sorting payment systems according to the parameters obtained from of a user.

### BACKGROUND OF THE INVENTION

For many years, the Internet has revolutionized the world of online electronic gaming. Like most industries, the gaming industry has continued to be network-friendly and has generally enabled players to participate in gaming events from their personal computers and in various regions. As a result, Internet or online gaming has become an extremely popular activity, resulting with numerous users logging into gaming sites and virtual reality worlds and participating in various games from their personal computers.

One feature of online gaming is making online payments, which generally requires the selection of payment options. For example, a user interested in playing an online game may be required to provide his or her credit card information in order to make a credit card payment. The user logs onto his or her gaming account, selects a payment option, and then processes the payment online. While there have been variations of these payment methods, the basic functionality of payments has not changed much since the advent of credit cards and online banking such as Paypal®.

Most conventional online payment methods, however, are generally limited. Specifically, current online payment options are generally restricted to credit cards or PayPal® and usually fail to offer payment options by mobile phone, credit, debit, prepaid cards, or a bank account. Additionally, most conventional payment systems are incapable of providing users with the most optimal local payment options to ensure that neither the payment method nor the user are subject to exorbitant fees or taxes.

Furthermore, most payment options are not uniquely tailored to each user. Most systems, for instance, lack a payment system method that is dynamic, based on the habits of each user, is customizable, and allows for various configurations. Most game publishers generally offer only online payment methods through credit cards and PayPal®, and these conventional methods do not offer customers the options they would want.

Therefore, what is needed is a method for providing payment options according to the parameters of a user most suited in the situation. Preferably, the method will provide the consumer to review alternate payment options, and preferably, the method may be uniquely tailored to each user.

### SUMMARY OF THE INVENTION

To minimize the limitations in the prior art, and to minimize other limitations that will become apparent upon reading and understanding the present specification, the present invention discloses a new and useful computer-based method for sorting payment systems.

One embodiment of the new method and system is a computer-based method for sorting payment systems, the steps comprising: providing an electronic data processing unit; wherein the electronic data processing unit is comprised of one or more applications and at least one display screen; obtaining one or more parameters of a user by the one or more applications; providing one or more payment systems by the one or more applications; providing one or more payment systems groups by the one or more applications; prioritizing the one or more payment systems groups by the one or more applications; populating at least one of the one or more payment systems groups with the one or more payment systems based upon the one or more parameters of the user, such that at least one populated payment systems group is created; sorting the one or more payment systems within the at least one populated payment systems group to create at least one sorted payment system; wherein the sorting step is based upon one or more sorting indicators; adding the at least one sorted payment system to a list; and displaying the list to the user in the at least one display screen of the electronic data processing unit. The prioritizing step of the one or more payment systems groups may be based upon the one or more parameters. The one or more parameters may be selected from the group of parameters consisting of: a project, a nickname, email, and an internet protocol address. The computer-based method may further comprise the step of: creating a least priority payment systems group; wherein the least priority payment systems group may be ranked lower than the other one or more payment systems groups; and wherein the least priority payment systems group may lack the one or more parameters. The sorting step of the one or more payment systems within the at least one populated payment systems group may be based upon a group index value and a payment systems index value. The group index value may be a priority value assigned to each of the one or more payment systems groups. The payment systems index value may be a weighted value assigned to the one or more sorting indicators. Each of the one or more sorting indicators may be assigned a priority level. The prioritizing of the one or more payment systems groups may be customizable by an administrator when the administrator selects one or more settings. The sorting step of the one or more payment systems groups may be customizable by a user when the user selects the one or more sorting indicators.

Another embodiment of the new method and system is a computer-based method for sorting payment systems, the steps comprising: providing an electronic data processing unit; wherein the electronic data processing unit is comprised of one or more applications and at least one display screen; providing one or more payment systems by the one or more applications; obtaining one or more parameters of a user by the one or more applications; providing one or more payment systems groups by the one or more applications; prioritizing the one or more payment systems groups by the one or more applications; wherein the prioritizing step of the one or more payment systems groups are based upon one or more parameters; populating at least one of the one or more payment systems groups with the one or more payment systems based upon the one or more parameters of the user, such that at least one populated payment systems group is created; sorting the one or more payment systems within the at least one populated payment systems group to create at least one sorted payment systems group; wherein the sorting step is based upon one or more sorting indicators, a group index value, and a payment systems index value; wherein the group index value is a priority value assigned to each of the one or more payment systems groups; wherein the payment systems index value is a weighted value assigned to the one or more sorting indicators; adding the at least one sorted payment systems group to a list; and displaying the list to the user in the at least one display screen of the electronic data processing unit. The one or more payment systems groups may be comprised of a first payment systems group; and wherein the one or more parameters of the first payment systems group may be comprised of a project, a nickname, and email. The one or more payment systems groups may be further comprised of a second payment systems group; wherein the second payment systems group may be ranked lower than the first payment systems group; and wherein the one or more parameters of the second payment systems group may be comprised of email. The one or more payment systems groups may be further comprised of a third payment systems group; wherein the third payment systems group may be ranked lower than the second payment systems group; and wherein the one or more parameters of the third payment systems group may be comprised of the project and an internet protocol address. The one or more payment systems groups may be further comprised of a fourth payment systems group; wherein the fourth payment systems group may be ranked lower than the third payment systems group; and wherein the one or more parameters of the fourth payment systems group may be comprised of the project and the internet protocol address. The one or more payment systems groups may be further comprised of a fifth payment systems group; wherein the fifth payment systems group may be ranked lower than the fourth payment systems group; and wherein the one or more parameters of the fifth payment systems group may be comprised of the project. The one or more payment systems groups may be further comprised of a sixth payment systems group; wherein the sixth payment systems group may be ranked lower than the fifth payment systems group; and wherein the one or more parameters of the sixth payment systems group may be comprised of the internet protocol address. The one or more payment systems groups may be further comprised of a seventh payment systems group; wherein the seventh payment systems group may be ranked lower than the sixth payment systems group; and wherein the one or more parameters of the seventh payment systems group may be the internet protocol address. The computer-based method may further comprising the step of: providing a least priority payment systems group; wherein the least priority payment systems group may be ranked lower than the other one or more payment systems groups; and wherein the least priority payment systems group may lack the one or more parameters.

Another embodiment of the new method and system is a computer-based method for sorting payment systems, the steps comprising: providing an electronic data processing unit; wherein the electronic data processing unit includes one or more applications and at least one display screen; providing one or more payment systems by the one or more applications; obtaining one or more parameters of a user by the one or more applications; providing one or more payment systems groups by the one or more applications; wherein the one or more payment systems groups are comprised of a first payment systems group; wherein the one or more parameters of the first payment systems group is comprised of a project, a nickname, and email; wherein the one or more payment systems groups are further comprised of a second payment systems group; wherein the second payment systems group is ranked lower than the first payment systems group; wherein the one or more parameters of the second payment systems group is comprised of email; wherein the one or more payment systems groups are further comprised of a third payment systems group; wherein the third payment systems group is ranked lower than the second payment systems group; wherein the one or more parameters of the third payment systems group is comprised of the project and an internet protocol address; wherein the one or more payment systems groups are further comprised of a fourth payment systems group; wherein the fourth payment systems group is ranked lower than the third payment systems group; wherein the one or more parameters of the fourth payment systems group is comprised of the project and the internet protocol address; wherein the one or more payment systems groups are further comprised of a fifth payment systems group; wherein the fifth payment systems group is ranked lower than the fourth payment systems group; wherein the one or more parameters of the fifth payment systems group is comprised of the project; wherein the one or more payment systems groups are further comprised of a sixth payment systems group; wherein the sixth payment systems group is ranked lower than the fifth payment systems group; wherein the one or more parameters of the sixth payment systems group is comprised of the internet protocol address; wherein the one or more payment systems groups are further comprised of a seventh payment systems group; wherein the seventh payment systems group is ranked lower than the sixth payment systems group; wherein the one or more parameters of the seventh payment systems group is comprised of the internet protocol address; providing a least priority payment systems group; wherein the least priority payment systems group is ranked lower than the other one or more payment systems groups; wherein the least priority payment systems group lacks the one or more parameters; prioritizing the one or more payment systems groups and the least priority payment systems group by the one or more applications; wherein the prioritizing step of the one or more payment systems groups are based upon one or more parameters; populating at least one of the one or more payment systems groups with the one or more payment systems based upon the one or more parameters; sorting the one or more payment systems within the at least one of the one or more populated payment systems groups to create at least one sorted payment systems group; wherein the sorting step is based upon one or more sorting indicators, a group index value, and a payment systems index value; wherein the group index value is a priority value assigned to each of the one or more payment systems groups; wherein the payment systems index value is a weighted value assigned to the one or more sorting indicators; adding the sorted payment systems group to a list; and displaying the list to the user in the at least one display screen of the electronic data processing unit.

It is an object of the new method and system to provide a software application that preferably simplifies: (1) the ranking of payment systems with automation; (2) the customization of a ranking system to a user; and (3) the determination of preferred payment systems in a variety of circumstances. As such, the software application preferably aids organizations that commit or receive large volumes of payments by expediting payment system identification and selection.

It is another object of the new method and system to offer payment options by mobile phone, micropayment, credit, debit, prepaid cards, or a bank account.

It is another object of the new method and system to provide the most optimal local payment options to ensure that neither the payment method nor the user is subject to exorbitant fees or taxes.

It is another object of the new method and system to provide payment options that are uniquely tailored to each user.

It is another object of the new method and system to provide a payment system that is dynamic, based on the habits of each user, and allows for various configurations.

It is another object of the new method and system to provide customers with the payment options that they would want.

It is another object of the new method and system to provide a computer-based method for providing payment options according to the parameters of a user most suited in the situation. Preferably, the method will provide the consumer to review alternate payment options, and preferably, the method will be uniquely tailored to each user.

It is an object of the new method and system to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is a block diagram of one embodiment of the computer-based method for sorting payment systems.

FIG. 2 is a table of the payment systems groups of one embodiment of the computer-based method for sorting payment systems.

FIGS. 3 and 4 are tables of the payment systems groups for one embodiment of the computer-based method and show the payment systems groups and their corresponding sorting indicators.

FIG. 5 is a graph of one embodiment of the computer-based method for sorting payment systems and shows the indicator weight calculations for three calculation methods with four indicator priority levels.

FIG. 6 is a screenshot of the application of one embodiment of the computer-based method for sorting payment systems and shows the list and settings of the application.

FIG. 7 is a screenshot of the application of one embodiment of the computer-based method for sorting payment systems and shows the payment selected page of the application.

FIG. 8 is a screenshot of the application one embodiment of the computer-based method for sorting payment systems and shows payment confirmation page of the application.

### DETAILED DESCRIPTION OF THE INVENTION

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the graphs, figures, and the detailed descriptions thereof, are to be regarded as illustrative in nature and not restrictive. Also, the reference or non-reference to a particular embodiment of the invention shall not be interpreted to limit the scope of the invention.

In the following description, certain terminology is used to describe certain features of one or more embodiments of the invention. For instance, the terms “computer” and “electronic data processing unit” refer to any device that processes information with an integrated circuit chip, including without limitation, mainframe computers, work stations, servers, desktop computers, portable computers, laptop computers, embedded computers, wireless devices including cellular phones, tablet computers, personal digital assistants, digital media players, portable game players, and hand-held computers.

The computer-based method proposed by the present invention is preferably a software application of an electronic data processing unit that preferably invokes means for analyzing and ranking payment systems or methods based upon details from prior payment transactions or other parameters. The computer-based method preferably includes at least two steps that automatically sort the list of payment systems. First, the list of payment systems are generally divided into groups with different group priority levels. Second, after the available payment systems are arranged in groups, each payment systems group may begin a sorting or ranking of the payment systems within each payment systems group based on indicator priority levels. Once payment systems are sorted and ranked, the sorted payment systems groups are consolidated or added to a final list, which is preferably displayed to the user. As such, the computer-based method preferably aids in the organization, identification and selection of payment systems to a user.

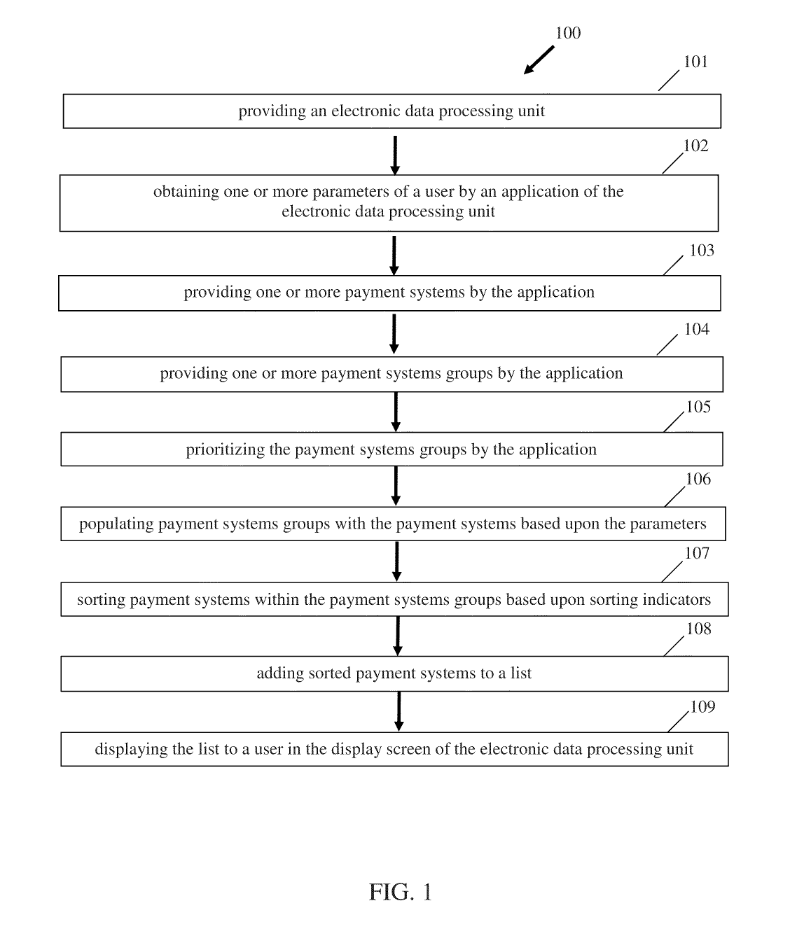

FIG. 1 is a block diagram of one embodiment of the computer-based method for sorting payment systems. As shown in FIG. 1, the computer-based method 100 preferably includes the steps of: providing an electronic data processing unit 101; obtaining one or more parameters of a user by an application of the electronic data processing unit 102; providing one or more payment systems by the application 103; providing one or more payment systems groups by the application 104; prioritizing the payment systems groups by the application 105; populating payment systems groups with payment systems based upon the parameters 105; sorting payment systems within the payment systems groups based upon sorting indicators 106; adding sorted payment systems to a list 108; and displaying the list to a user in the display screen of the electronic data processing unit 109.

FIG. 1 shows the first step of one embodiment of the computer-based method 100, which is providing an electronic data processing unit 101. As discussed above, an electronic data processing unit is typically any general purpose device that carries out or performs a finite set of arithmetic or logical operations. The electronic data processing unit typically comprises of a bus, processor, memory, mass storage device, and other input/output devices and may also include one or more displays, a keyboard or keypad, and a pointing device. The electronic data processing unit may also include other components without deviating from the scope of the invention. Preferably, the electronic data processing unit is a personal computer desktop or laptop, but may be any type of computing device such as a tablet, mobile/cellular phone, or the like.

The electronic data processing unit will preferably have at least one application, which is preferably a software program with a user interface configured to receive or obtain one or more user inputs or parameters and analyze data sent or received by the electronic data processing unit. Additionally, the application is preferably configured to group payment systems groups, sort payment systems within a group, and provide generated lists, confirmations, and/or notifications that will preferably be sent to the user or administrator. The software application may include an administrative login and a standard user login. The administrative login preferably provides administrative users or designated personnel with one or more administrative privileges while the standard user login preferably provides users with standard privileges. An administrative privilege refers to a high level of permission that is granted to a computer user, which typically includes creating user accounts/user profiles; creating/categorizing groups; and accessing alerts or notifications. However, an administrative privilege may include other privileges as well. The standard privilege refers to the basic permissions that are granted to a user, which typically includes choosing group settings, adding or removing indicator settings, and selecting a payment. However, like administrative privileges, standard privileges may also include other privileges as well. Preferably, the application prompts the user to begin the sorting method, and the prompt may be a start page, homepage, or a tutorial walkthrough. The user may also begin by selecting an input source or by choosing a desired payment systems setting.

Finally, the electronic data processing unit preferably has at least one display screen to display a list of results to a user. The display screen may be any electronic visual display for computers and may include, without limitation, an liquid crystal display (LCD), cathode ray tube (CRT), light emitting diode (LED), and the like.

FIG. 1 also shows the second step of one embodiment of the computer-based method 100, which is obtaining one or more parameters of a user by an application of the electronic data processing unit 102. The parameters may be any automatically obtained or inputted from a default source, a source selected by the user or application, or any manually input variables set by the user or application. An input source may also be a library or database on the electronic data processing unit or through a connection to another electronic data processing unit.

In one embodiment, the parameters may be the payment details associated with a payment system. For example, a project, nickname, email, or an internet protocol address may be the parameters. The parameters may be known or recorded from prior payments or may be a variable and may have one or more associated values. For instance, a project parameter for an online game may have the associated value such as “desert storm” or an equivalent. Furthermore, a parameter may be a calculated or automatically recorded by the application of the electronic data processing unit.

FIG. 1 shows the third step of one embodiment of the computer-based method 100, which is providing one or more payment systems by the application 103. A payment system is generally defined as one or more payment mechanisms, methods, or payment services configured to allow a user to fund one or more projects (e.g., game or software applications), services, or goods, including without limitation online banks such as Paypal®, credit cards, debit cards, prepaid cards, bank accounts and the like. The payment system is preferably provided by the provided by the application or computer-based method 100 but may be provided by the user or administrator. The payment systems may be provided from an electronic source such as database or server or any storage unit of an electronic data processing unit such as an internal hard drive, external hard drive, computer readable mediums, the Internet, and the like.

The payment systems may be created before the parameters are inputted by the user; after the parameters are inputted by the user; or upon initialization of the application or electronic data processing unit.

FIG. 1 shows the fourth step of one embodiment of the computer-based method 100, which is providing one or more payment systems groups by the applications 104. The payment systems group is generally defined as one or more payment systems that share one or more common attributes. Specifically, the attributes of a payment systems group may be the requirements for a payment system to belong to a particular payment systems group. Payments systems groups may contain any number of payment systems, and the payment systems groups may utilize arrays, lists, libraries, or object-oriented techniques to store the various payment systems. The application may also create by default a fixed number of payment systems groups, or alternatively, create a number of payment systems groups chosen by the administrator. The administrative may also add and/or remove groups.

Additionally, the application may create a payment systems group with no requirements (e.g., least priority payment systems group), and this group may serve as a catchall, default, or null group to categorize payment systems that do not meet the requirements of other payment systems group.

Like the payment systems, the payment systems groups may be created before the parameters are inputted by the user; after the parameters are inputted by the user; or upon initialization of the application or electronic data processing unit.

FIG. 1 also shows the fifth step of one embodiment of the computer-based method 100, which is prioritizing the payment systems groups by the applications 105. Preferably, the application prioritizes the payment systems groups when the payment systems groups are created or immediately thereafter. The application also preferably prioritizes the groups based upon the number of parameters, information, or attributes contained in a payment systems group. For example, if a user inputs more parameters that are applicable to a certain payment systems group, that payment systems group may likely have a higher ranking in group priority (e.g., the first payment systems group may have multiple parameters satisfying the information about the user, project, and nickname of the user, whereas the second payment systems group may only have a single parameter such as user information alone). Similarly, a payment systems group that requires a specific project such as a game may be prioritized over a group that requires any project. On the other hand, a group with a lower numerical value for its priority is generally prioritized first. For example, a group with priority level “1” is generally prioritized before a group with priority level “2.” Additionally, the least priority payment systems group such as a catchall group with no requirements may be prioritized last.

FIG. 1 shows the sixth step of one embodiment of the computer-based method 100, which is populating the payment systems groups with the payment systems based upon the parameters 106. The populating step may be done in order of priority. Thus, a group with priority level “1” may be populated first, whereas a group with priority level “2” may be populated next. A payment system may populate more than one group, and when populating a group, the application may check a complete list of all payment systems to determine whether each payment system has the required parameters. If a payment system has the required parameters of a payment systems group, the group is preferably populated with that payment system. Alternatively, a payment systems group may be populated with less than the required parameters without deviating from the scope of the invention.

The populating step may be based upon the presence of a single parameter, a group of parameters, or upon its associated value. For instance, in one embodiment, a payment system that has a parameter of a project may populate a group that requires any project. One example is a payment system that has a project parameter with the associated value “desert storm”, which may populate a group that requires the specific project “desert storm.” On the other hand, a payment system that has a project parameter “desert sand” may not populate that group.

FIG. 1 shows the seventh step of one embodiment of the computer-based method 100, which is sorting the payment systems within the payments systems groups based upon the sorting indicators 107. The sorting indicators are preferably one or more standardized criteria. Specifically, when sorting the payment systems within a group, the payment systems are generally analyzed in relation to those sorting indicators. The sorting indicators may include: total revenue, revenue from fees, date of last payment, and/or the number of payments. Sorting indicators may also utilize their group parameter requirements. For instance, a group that specifically requires a project parameter with associated value “desert storm” and a sorting indicator for total revenue may sort its payment systems according to their total revenue from the project “desert storm.” The sorting step is preferably performed according to group priority in the same manner as the populating step, as discussed above.

The sorting step may consider weighted values for sorting indicators, and one sorting indicator may have more weight or emphasis than another sorting indicator within its payment systems group. The weight of each sorting indicator may also be performed based upon the differing calculation methods. Furthermore, the weight of sorting indicators may be based upon a user input, such that a user may be allowed to distinguish a sorting indicator as “high priority” and cause the sorting indicator to influence the sorting process more.

Finally, FIG. 1 shows the eighth and ninth steps of one embodiment of the computer-based method 100, which are adding sorted payment systems to a list 108, and displaying the list to a user in the display screen of the electronic data processing unit 109. Adding the sorted payment systems may be performed according to group priority in the same manner as the populating step, as discussed above. Specifically, the adding of the sorting payment systems is generally added based upon the levels of priority of each group and the priority of each payment system within each group. Thus, the list displayed to the user should reflect the group priority and the sorting step within each of the payment systems groups. The displayed list may reflect a payment systems group priority according to the position on the display and/or a numbering/ranking system. The displayed list may also reflect payment systems according to the position on the display and/or according to a numbering/ranking system.

### Populating One or More Payment Systems Groups with One or More Payment Systems

Preferably, the computer based method 100 will create one or more payment systems groups for one or more payment systems. Each group may be populated with an array of one or more payment systems and generally are not populated if certain conditions are not met. For example, in one embodiment, the first payment systems group may be empty if: (1) the parameters inputted by the user are insufficient for the group and/or (2) the user has not committed any payments previously.

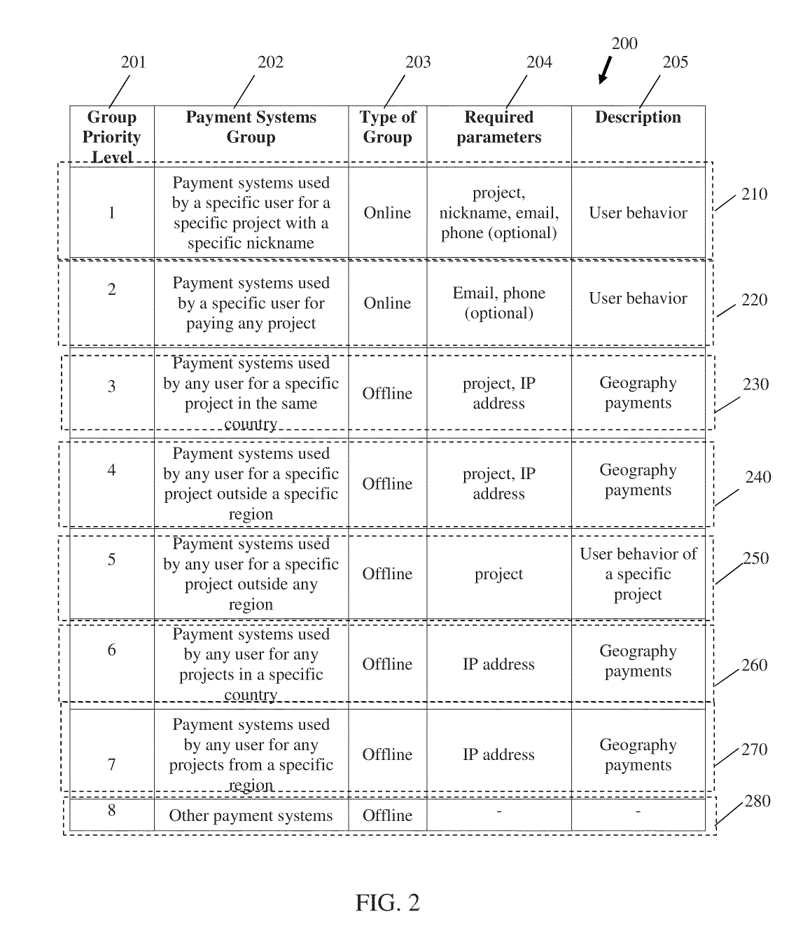

FIG. 2 is a table of the payment systems groups of one embodiment of the computer-based method for sorting payment systems. As shown in FIG. 2, the computer-based method 200 preferably include a plurality of payment systems groups, which may include: a first payment systems group 210; second payment systems group 220; third payment systems group 230; fourth payment systems group 240; fifth payment systems group 250; sixth payment systems group 260; seventh payment systems group 270; and eighth payment systems group 280. Furthermore, each payment systems group 202 preferably includes a group priority level and may have one or more required parameters 204. Each payment systems group 202 may also be classified by a group type 203 and description 205. The group priority level 201 is preferably the level that may be assigned to particular payment systems group 202 and generally specifies the order in which a payment system or payment systems group is to be displayed to a user. The payment systems group 202, as discussed above, is preferably one or more payment systems that are grouped based upon one or more common attributes. The type of group 203 is preferably a category of payment systems group that is classified as either online or offline. A payment system that is classified online may be ranked at the request of the user, whereas a payment system that is classified offline may be sorted periodically, with the results being stored in a separate array or table. The group description 205 is preferably one or more characteristics or attributes that describe the payment systems group 202.

In one embodiment, FIG. 1 shows that the computer-based method 200 may have eight payment systems groups. For example, the first payment systems group 210 may be one or more payment systems used by a specific user for a specific project or game, wherein the user has a username or nickname for that particular project or game. The first payment systems group 210 may also be directed to online payment systems and is generally focused on the behavior of the user. The first payment systems group 210 may have the highest priority level and may be designated with a group priority level of “1”. Furthermore, the first payment systems group 210 may utilize the following parameters: the project, nickname or username of that project, and email address. The first payment systems group 210 may also include additional parameters inputted by the user such as a phone number.

FIG. 2 also shows the second payment systems group 220, which may be one or more payment systems used by a specific user for any project or game. The second payment systems group 220 may be directed to online payment systems and may be focused on the behavior of the user. The second payment systems group 220 may be ranked second in the priority level and may be designated with a group priority level of “2”. Furthermore, the second payment systems group 220 may utilize an email address as a parameter and may also include additional parameters inputted by the user such as a phone number.

FIG. 2 shows the third payment systems group 230, which may be one or more payment systems used by any user for a specific project or game of the same country. The third payment systems group 230 may be directed to offline payment systems and may be generally focused on geography payments. The third payment systems group 220 may be ranked third in the priority level and may be designated with a group priority level of “3”. Furthermore, the third payment systems group 230 may utilize the project and Internet Protocol (IP) address as the parameters.

The fourth payment systems group 240 may be one or more payment systems used by any user for a specific project or game, wherein the payment of the project or game is made outside a specific region. The fourth payment systems group 240 may be directed to offline payment systems and may be focused on geography payments. The fourth payment systems group 240 may be ranked fourth in the highest priority level and may be designated with a group priority level of “4”. Furthermore, the fourth payment systems group 240 may be utilize the project and IP address as the parameters.

The fifth payment systems group 250 may be one or more payment systems used by any user for a specific project or game, wherein the payment of the project or game is made outside any region. The fifth payment systems group 250 may be directed to offline payment systems and may be focused on the behavior of the user. The fifth payment systems group 250 may be ranked fifth in the priority level and may be designated with a group priority level of “5”. Furthermore, the fifth payment systems group 250 may utilize the project as the parameter.

The sixth payment systems group 260 may be one or more payment systems used by any user for any project or game, wherein the payment of the project or game is made out of specific country. The sixth group 260 may be directed to offline payment systems and may be focused on geography payments. The sixth payment systems group 260 may be ranked sixth in the priority level and may be designated with a group priority level of “6”. Furthermore, the sixth payment systems group 260 may utilize an IP address as the parameter.

The seventh payment systems group 270 may be one or more payment systems used by any user for any project or game, wherein the payment of the project or game is made out of a specific region. The seventh payment systems group 270 may be directed to offline payment systems and may be focused on geography payments. The seventh payment systems group 270 may be ranked seventh in the priority level and may be designated with a group priority level of “7”. Furthermore, the seventh payment systems group 270 may utilize an IP address as the parameter.

Finally, the eighth payment systems group 280 may be a catch-all for one or more payment systems used that may be directed to offline payment systems and may lack any parameters. The eighth payment systems group 280 may have the lowest priority level and may be designated with a group priority level of “8”.

Although FIG. 2 displays eight payment systems groups, it should be understood that the present invention may display more or less than eight payment systems groups without deviating from the scope of the present invention.

### Sorting One or More Payment Systems within at Least One Payment Systems Groups

After the payment systems groups are created and populated with one or more payment systems, the computer-based method 100, 200, 300 preferably sorts the payment system within each payment systems group. The sorting step is preferably performed by calculating a consolidated index for the payment systems. In one embodiment of the computer-based method 100, 200, 300, the consolidated index may be calculated by the formula:

CONSOLIDATED_INDEX=GROUP_INDEX*10000+PS_INDEX

where the term CONSOLIDATED_INDEX is preferably the final calculated value assigned to each payment system that is graded or ranked; GROUP_INDEX is preferably the group priority level assigned to each payment system according to particular payment systems group and preferably after the prioritizing step of the payment systems groups; and PS_INDEX is preferably the indicator priority level assigned to each payment system within each payment systems group. The formula may also include a scale factor (e.g., 10000) to emphasize the ranking of the group priority level GROUP_INDEX with respect to the indicator priority level PS_INDEX. Once the CONSOLIDATED_INDEX is calculated, each payment system is preferably added to a final list based upon the CONSOLIDATED_INDEX value. The list is also preferably displayed to the user.

As discussed above, GROUP_INDEX is preferably the group priority level assigned to each payment system according to the grouping or prioritizing of a payment systems group. For example, as shown in FIG. 2, if only the first two payment systems groups are used (e.g., first payment systems group 210 and second payment systems group 220), then the value for GROUP_INDEX for first payment systems group 210 and second payment systems group 220 respectively, according to FIG. 2, may be calculated as follows:

GROUP_INDEX (first payment systems group)=1

GROUP_INDEX (second payment systems group)=2

Similarly, if only three payment systems groups are used (e.g., first payment systems group 210, second payment systems group 220, and fourth payment systems group 240), then the value for GROUP_INDEX for first payment systems group 210, second payment systems group 220, and fourth payment systems group 240, according to FIG. 2, may be calculated as follows:

GROUP_INDEX (first payment systems group)=1

GROUP_INDEX (second payment systems group)=2

GROUP_INDEX (fourth payment systems group)=4

These GROUP_INDEX values are preferably calculated with a scale factor (e.g., 10000) to emphasize the grouping or prioritizing of each payment systems group as well as the final CONSOLIDATED_INDEX value for each payment system.

Regarding the PS_INDEX value, as discussed above, each payment system is preferably assigned an indicator priority level within each payment systems group, and each indicator priority level is generally assigned a value (i.e., PS_INDEX). Thus, this value is usually determined based upon the corresponding sorting indicator(s). The values assigned by PS_INDEX may also be differentiated for each payment systems group based upon certain weights assigned to each sorting indicator. Furthermore, the weight of each sorting indicator may also be based upon the assessment of the significance for each sorting indicator.

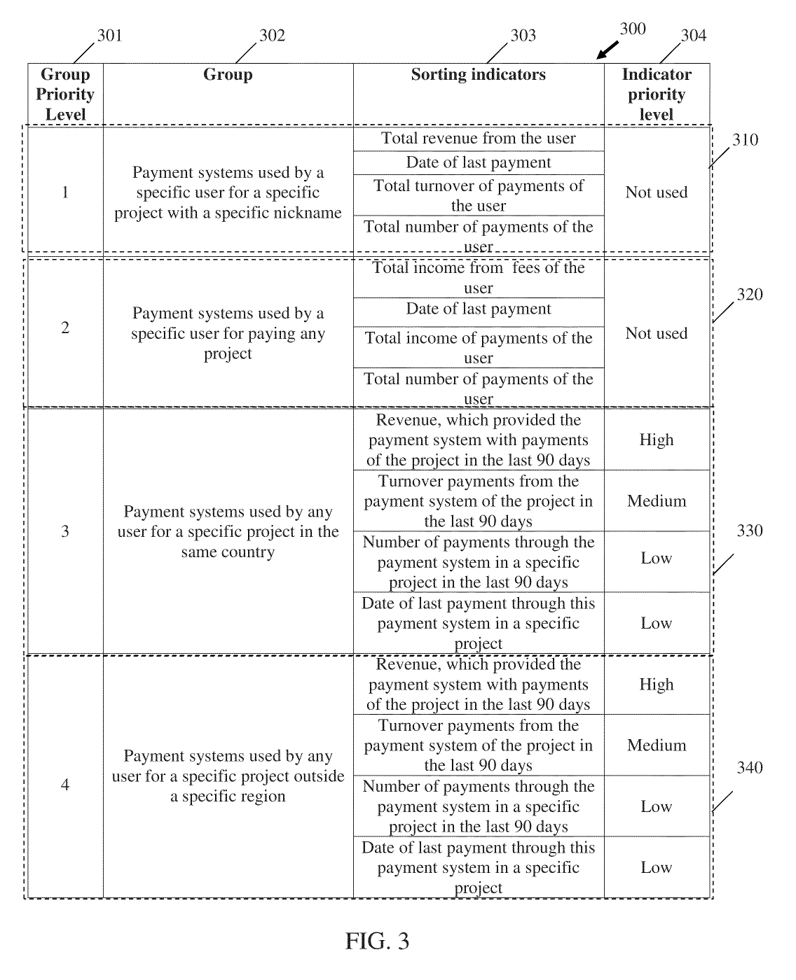

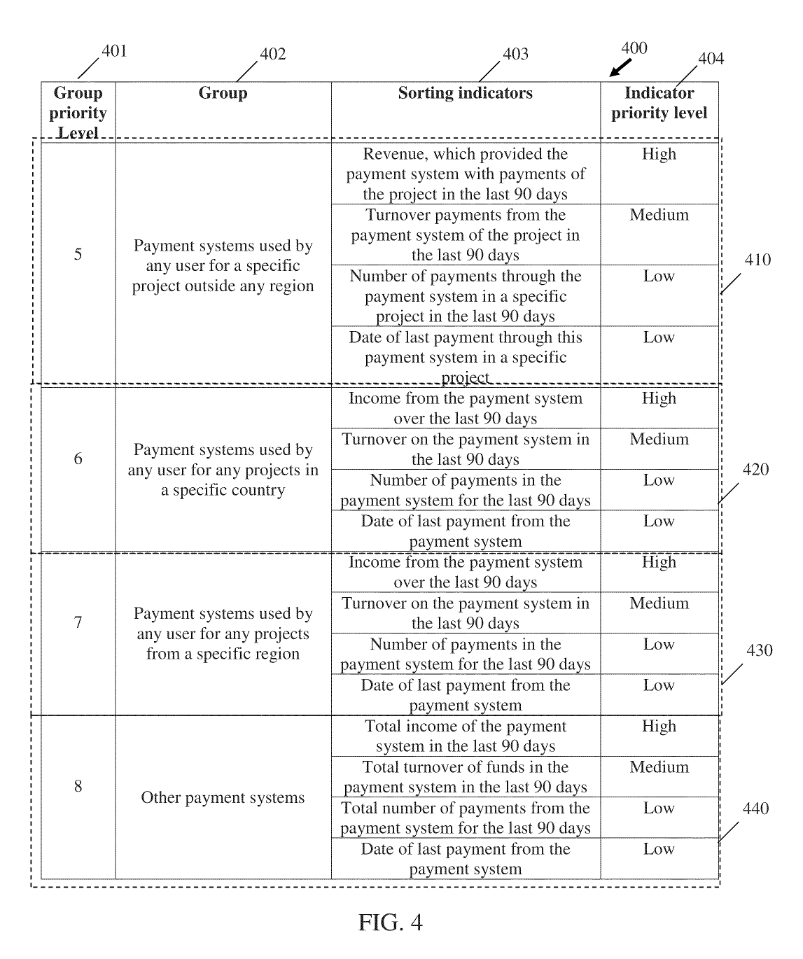

FIGS. 3 and 4 are tables of the payment systems groups for one embodiment of the computer-based method and show the payment systems groups and their corresponding sorting indicators. As shown in FIGS. 3 and 4, the computer based method 300, 400 preferably includes a plurality of payment systems groups, which may include: a first payment systems group 310; second payment systems group 320; third payment systems group 330; fourth payment systems group 340; fifth payment systems group 410; sixth payment systems group 420; seventh payment systems group 430; and eighth payment systems group 440. Furthermore, as discussed above, each payment systems group 302, 402 preferably includes a group priority level 301, 401 and may have one or more sorting indicators 303, 403. Each sorting indicator 303, 403 also preferably includes a corresponding indicator priority level 304, 404. The group priority level 301, 401 is preferably the level that may be assigned to particular payment systems group 302, 402 and each sorting indicator 303, 403 is preferably used as a basis to sort, rank, or prioritize each payment system within a payment systems group 302, 402. The indicator priority level 304, 404 is preferably the level or value that may be assigned to particular sorting indicator 303, 403, and preferably, each payment system is ranked based upon the indicator priority level 304, 404. Furthermore, the value of each indicator priority level 304, 404 may be weighted based upon the preferences or parameters of the administrator and/or user.

The first payment systems group 310 (i.e., payment systems used by a specific user for a specific project with a specific nickname), for example, may include the following sorting indicators 303: total revenue from the user; date of last payment; total turnover of payments of the user; and total number of payments of the user. These sorting indicators 303 generally lack a sorting priority level, but the payment systems within the first payment systems group 310 preferably have a group priority level of “1”.

Similarly, the second payment systems group 320 (i.e., payment systems used by a specific user for paying any project) preferably includes the following sorting indicators 303: total income from fees of the user; date of last payment; total income of payments of the user; and total number of payments of the user Like the first payment systems group 310, these sorting indicators 303 generally lack a sorting priority level, but the payment systems within the second payment systems group 320 preferably have a group priority level of “2”.

FIGS. 3 and 4 show that the third payment systems group 330 (i.e., payment systems used by any user for a specific project in the same country), fourth payment systems group 340 (i.e., payment systems used by any user for a specific project outside a specific region), and fifth payment systems group 410 (i.e., payment systems used by any user for a specific project outside any region) may have four sorting indicators 303, 403. These sorting indicators 303, 403 may include: (1) revenue, which provided the payment system with payments of the project in the last 90 days; (2) turnover payments from the payment system of the project in the last 90 days; (3) number of payments through the payment system in a specific project in the last 90 days; and (4) date of last payment through this payment system in a specific project. These sorting indicators 303, 403 may also be assigned an indicator priority level 304, 404 of: (1) high; (2) medium; (3) low; and (4) low, respectively. Furthermore, the third payment systems group 330, fourth payment systems group 340, and fifth payment systems group 410 preferably have a group priority level of “3”, “4”, and “5”, respectively.

FIG. 4 show that the sixth payment systems group 420 (i.e., payment systems used by any user for any projects in a specific country) and seventh payment systems group 430 (i.e., payment systems used by any user for any projects from a specific region) may have four sorting indicators 403. The sorting indicators 403 may include: (1) income from the payment system over the last 90 days; (2) turnover on the payment system in the last 90 days; (3) number of payments in the payment system for the last 90 days; and (4) date of last payment from the payment system. These sorting indicators 403 may also be assigned an indicator priority level 404 of: (1) high; (2) medium; (3) low; and (4) low, respectively. Furthermore, the sixth payment systems group 420 and seventh payment systems group 430 preferably have a group priority level of “6” and “7”, respectively.

Finally, FIG. 4 shows that the eighth payment systems group 440 (i.e., other payment systems) may have four sorting indicators 403, which may include: (1) total income of the payment system in the last 90 days; (2) total turnover of funds in the payment system in the last 90 days; (3) total number of payments from the payment system for the last 90 days; and (4) date of last payment from the payment system. These sorting indicators 403 preferably have an indicator priority level 404 of: (1) high; (2) medium; (3) low; and (4) low, respectively. The eighth payment systems group 440 also preferably has a group priority level of “8”. Although FIGS. 3 and 4 only show eight payment systems groups, it should be understood that the computer-based method for may include more or fewer payment systems groups without deviating from the scope of the invention.

FIGS. 3 and 4, also show that the indicator priority level 304, 404 may be assigned a level as: (1) high; (2) medium; or (3) low. These indicator priority levels may be weighted, such that the value of PS_INDEX may be increased, linear, or decreased based on its priority level in the selected calculation scheme. For example, when calculating the values based on weights using three methods:
a¹ (linear)
a^{0.5} (decreasing)
a^{1.75} (increasing)
   where a is preferably the corresponding indicator priority level 304, 404 selected in a particular scheme of calculations. Thus, the Table 1, shown below, preferably shows the values of weights for each different method of calculation:

TABLE 1

| | Indicator weight calculation method | | |
|---|---|---|---|
| Indicator priority level | α¹(linear) | α^{0.5} (decreasing) | α^{1.75} (increasing) |
| High | 3.000 | 1.732 | 6.839 |
| Medium | 2.000 | 1.414 | 3.364 |
| Low | 1.000 | 1.000 | 1.000 |

Accordingly, the value of PS_INDEX may be calculated by assigning the weighted value for each indicator priority level assigned to each payment system, wherein each indicator priority level may be based, according to the sorting indicators of a particular payment systems group.

FIG. 3, for example, shows that, if a payment system is assigned to a first payment systems group 310 and has the sorting indicator “total revenue from the user”, then the payment system would preferably have a group priority level of “1” with no weighted indicator priority level. Similarly, as shown in FIG. 4, if a payment system is assigned to a fifth payment systems group 410 and has the sorting indicator “revenue, which provided the payment system with payments of the project in the last 90 days”, then a sorting indicator of “high” will preferably be assigned to the payment system. This payment systems group may have a weighted PS_INDEX value of either: 3.000 for linear weight calculations, 1.732 for decreasing weight calculations, or 6.839 for increasing weight calculations.

An advantage of this weighted calculation method is that additional indicator priority levels and weighted values may be added without adversely affecting the CONSOLIDATED_INDEX=GROUP_INDEX*10000+PS_INDEX formula. For example, when considering Table 2, where a fourth “highest” priority level is added to the computer-based method:

| | Indicator weight calculation method | | |
|---|---|---|---|
| Indicator priority level | α¹ (linear) | α^{0.5} (decreasing) | α^{1.75} (increasing) |
| Highest | 4.000 | 2.000 | 11.314 |
| High | 3.000 | 1.732 | 6.839 |
| Medium | 2.000 | 1.414 | 3.364 |
| Low | 1.000 | 1.000 | 1.000 |

As shown in Table 2, the indicator priority level 304, 404 may be assigned four different levels such as: (1) highest; (2) high; (3) medium; or (4) low. Like Table 1, these indicator priority levels may be weighted, such that the value of PS_INDEX may be ranked with a different value for each payment system in the selected calculation scheme. Thus, when calculating the values using weights, the payment systems group with a “highest” indicator priority level may have a weighted PS_INDEX value of either: 4.000 for linear weight calculations, 2.000 for decreasing weight calculations, or 11.314 for increasing weight calculations. These values are preferably assigned to PS_INDEX and may affect the final CONSOLIDATED_INDEX value when creating the list.

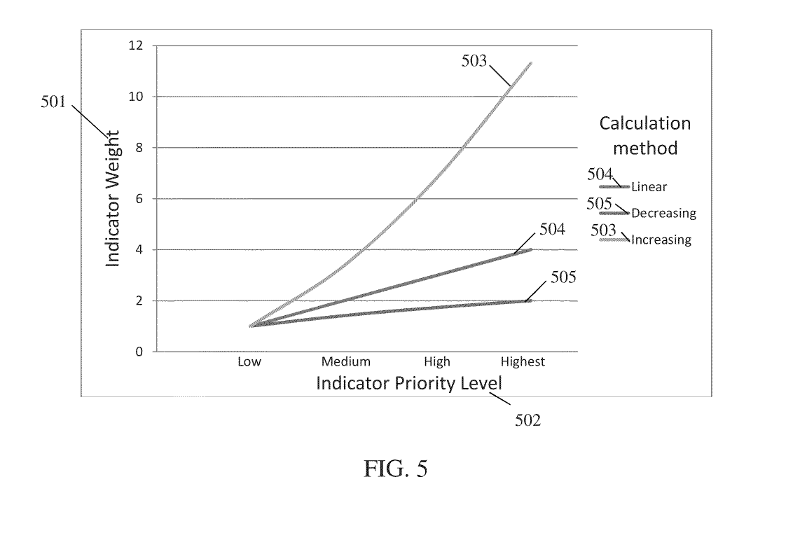

FIG. 5 is a graph of one embodiment of the computer-based method for sorting payment systems and shows the indicator weight calculations for three calculation methods with four indicator priority levels. As shown in FIG. 5, the computer-based method may include: an indicator weight level 501; indicator priority level 502; increasing calculation method 503; linear calculation method 504; and decreasing calculation method 505. The indicator weight level 501 is preferably the calculated weight level or PS_INDEX value assigned to a particular payment system. The indicator priority level 502 is preferably the assigned level of each payment system according to the sorting indicators of a particular payment systems group. The increasing calculation method 503 is preferably the calculating method that assigns a value based on an increasing numerical calculation (e.g., a^{1.75} (increasing)). The linear calculation method 504 is preferably the calculating method that assigns a numerical value based on a linear calculation method (e.g., a¹ (linear)), and the decreasing calculation method 505 is preferably the calculating method that assigns a numerical value based upon a decreasing calculation method (e.g., a^{1.75} (increasing)). For example, as shown in FIG. 5, when calculating the weighted value for PS_INDEX for a payment systems group using a decreasing calculation method 505 with the highest indicator priority level 502, the indicator weight PS_INDEX may have a value of 2. Similarly, when calculating the weighted value for PS_INDEX for a payment systems group using a linear calculation method 504 with the highest indicator priority level 502, the indicator weight PS_INDEX may have a value of 4.

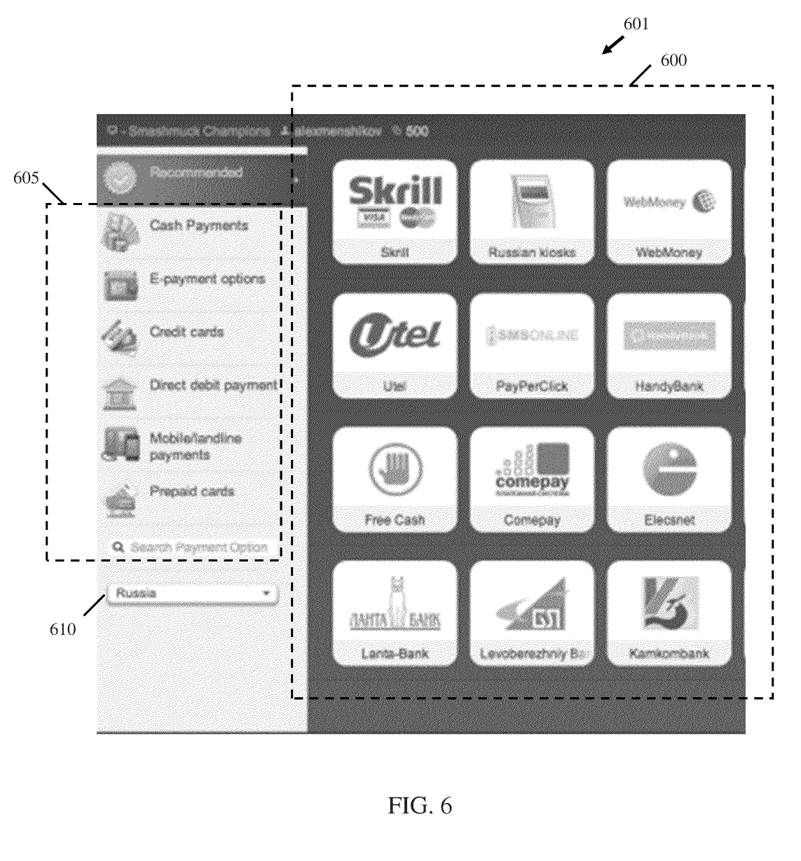

FIG. 6 is a screenshot of the application of one embodiment of the computer-based method for sorting payment systems and shows the list and settings of the application. As shown in FIG. 6, the screenshot 601 of one embodiment of the computer-based method may include: a list 600; filters 605; and a region selector 610. The list 600 preferably includes the sorted payment systems, which are preferably displayed according to the PS_INDEX value or indicator weight level 501. The sorted payment systems with the highest indicator weight level 501 or PS_INDEX may be positioned in decreasing order based upon the indicator weight level 501. This generally allows a user to quickly view the list 600 which are preferably calculated based upon the CONSOLIDATED_INDEX value. The filters 605 preferably allow a user to manually select a particular payment type, preferably based on the needs or parameters of the individual user. The region selector 610 preferably allows a user to select which country they currently reside in. This generally allows the computer-based method to sort based on geographic location if the IP address of the user does not accurately reflect the geographic location of the user. The user preferably selects a payment system from the list 600 to select the appropriate payment system. Selecting a payment type using the filters 605 and selecting a country using the region selector 610 may affect which payment options 600 are to be displayed. The use of the filters 605 and the region selector 610 may also affect what payment systems are to be displayed. Additionally, various factors, including previous purchase history or what other users select may affect which payment systems are to be displayed.

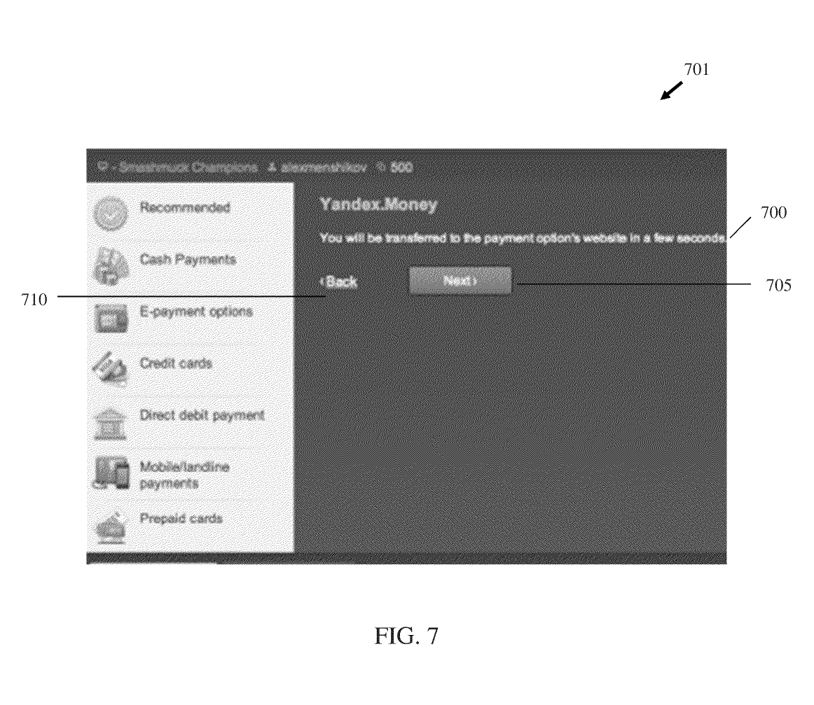

FIG. 7 is a screenshot of the application of one embodiment of the computer-based method for sorting payment systems and shows the payment selected page of the application. As shown in FIG. 7, the screenshot 701 of one embodiment of the computer-based method may comprise: a message 700; a next button 705; and a back button 710. Preferably, the message 700 explains to a user the status of a selection or the options of the user. The next button 705 preferably allows the user to proceed to the next page, which may be a payment confirmation page, order summary, list 600, web page, or other page. As status page may also display to provide information details about payment to the user. The back button 710 preferably returns the user to a previous page, such as a page which displays filters 605 where the user may choose a different payment system than originally chosen.

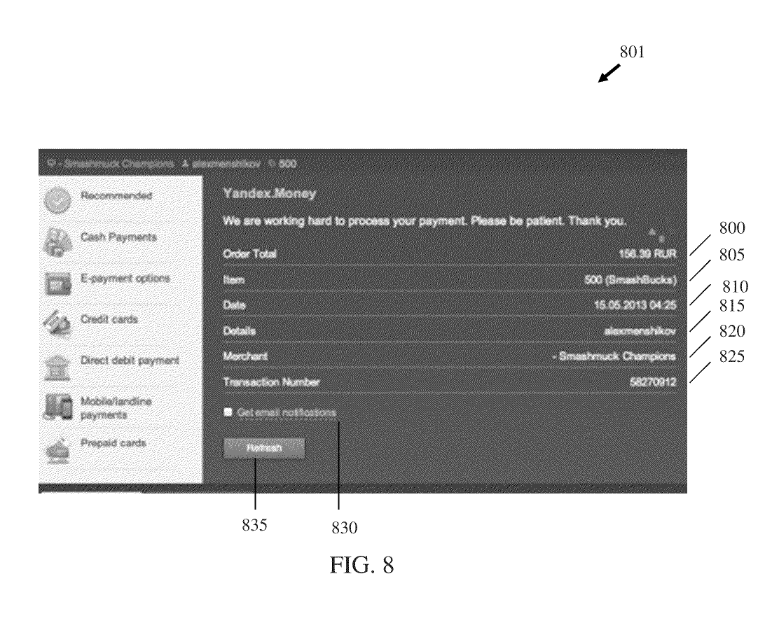

FIG. 8 is a screenshot of the application one embodiment of the computer-based method for sorting payment systems and shows payment confirmation page of the application. As shown in FIG. 8, the payment confirmation screen 801 of the computer-based method may comprise: an order total 800; an item description 805; a date 810; purchase details 815; a merchant name 820; a transaction number 825; an email notification box 830; and a refresh button 835. Preferably, the order total 800 informs the user of the monetary value of the purchase. Preferably, the item description 805 informs the user of what the user is purchasing in this transaction. Preferably, the date 810 informs the user of the time when the purchase was made. Preferably, the purchase details 815 gives the user a description of what the purchase is relating to. Preferably, the merchant name 820, informs the user of where the user is making the purchase. Preferably, the transaction number 825 informs the user the reference number of his or her transaction. Preferably, the email notification box 830 allows a user to have information regarding the purchase to be sent to the email address of the user. Preferably, the refresh button 835 allows the user to reload the webpage. The computer-based method may also include the step of sending a confirmation email to a user, regarding a particular status of payment.

Regarding customization, the structure setting of the computer-based method may be customized according to the preference or parameters of an administrator and/or user. For example, the settings of the sorting algorithm may be adjusted by amending the payment systems groups. The user may add or remove an offline-group (preferably, except the least priority payment systems group) and preferably may not change the order of the populating of the payment systems groups, which is generally calculated based upon the group priority levels. Additionally, the sorting indicators may be changed, such that a user may add or remove any sorting indicator from the consolidated index for any offline group. Furthermore, the indicator priority level may be also be adjusted without deviating from the scope of the invention.

In unique cases, the computer-based method may allow an administrator to manually customize or adjust the list of a payment system. This may be used for situations when an individual payment system has weak parameters (e.g., importance of a payment system regarding a particular project, the novelty of the payment system, and the need for further promotion of the payment system, etc. . . . ). Thus, the administrator may transfer one payment system from one place to another place. Other customizations to the computer-based method may include: customizing the list of available payment systems groups; customizing the list of available sorting indicators; and customizing the list and order of available group priority levels and indicator priority levels.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

The foregoing description of the preferred embodiment of the invention has been presented for the purposes of illustration and description. While multiple embodiments are disclosed, still other embodiments of the present invention will become apparent to those skilled in the art from the above detailed description, which shows and describes illustrative embodiments of the invention. As will be realized, the invention is capable of modifications in various obvious aspects, all without departing from the spirit and scope of the present invention. Accordingly, the detailed description is to be regarded as illustrative in nature and not restrictive. Also, although not explicitly recited, one or more embodiments of the invention may be practiced in combination or conjunction with one another. Furthermore, the reference or non-reference to a particular embodiment of the invention shall not be interpreted to limit the scope the invention. It is intended that the scope of the invention not be limited by this detailed description, but by the claims and the equivalents to the claims that are appended hereto.

Except as stated immediately above, nothing which has been stated or illustrated is intended or should be interpreted to cause a dedication of any component, step, feature, object, benefit, advantage, or equivalent to the public, regardless of whether it is or is not recited in the claims.

What is claimed is:

1. A computer-based method for sorting payment systems, the steps comprising:
providing one or more applications that are configured to run on an electronic data processing unit;
wherein said electronic data processing unit comprises at least one display screen;
receiving one or more parameters of a user by said one or more applications;
providing one or more payment systems by said one or more applications;
providing one or more payment systems groups by said one or more applications;
prioritizing said one or more payment systems groups by said one or more applications;
populating at least one of said one or more payment systems groups with said one or more payment systems based upon said one or more parameters of said user, such that at least one populated payment systems group is created;
sorting said one or more payment systems within said at least one populated payment systems group to create at least one sorted payment system;
wherein said sorting step is based upon one or more sorting indicators;
adding said at least one sorted payment system to a list; and
displaying said list in said at least one display screen of said electronic data processing unit.

2. The computer-based method of claim 1, wherein said prioritizing step of said one or more payment systems groups are based upon said one or more parameters.

3. The computer-based method of claim 2, wherein said one or more parameters are selected from the group of parameters consisting of: a project, a nickname, email, and an internet protocol address.

4. The computer-based method of claim 3, further comprising the step of:
creating a least priority payment systems group;
wherein said least priority payment systems group is ranked lower than said other one or more payment systems groups; and
wherein said least priority payment systems group lacks said one or more parameters.

5. The computer-based method of claim 1, wherein said sorting step of said one or more payment systems within said at least one populated payment systems group is based upon a group index value and a payment systems index value.

6. The computer-based method of claim 5, wherein said group index value is a priority value assigned to each of said one or more payment systems groups.

7. The computer-based method of claim 6, wherein said payment systems index value is a weighted value assigned to said one or more sorting indicators.

8. The computer-based method of claim 7, wherein each of said one or more sorting indicators is assigned a priority level.

9. The computer-based method of claim 1, wherein said prioritizing of said one or more payment systems groups is configured to be customizable by an administrator when said administrator selects one or more settings.

10. The computer-based method of claim 1, wherein said sorting step of said one or more payment systems groups is customizable by based on a selection of said one or more sorting indicators.

11. A computer-based method for sorting payment systems, the steps comprising:
providing one or more applications that are configured to run on an electronic data processing unit;
wherein said electronic data processing unit comprises at least one display screen;
providing one or more payment systems by said one or more applications;
receiving one or more parameters of a user by said one or more applications;
providing one or more payment systems groups by said one or more applications;
prioritizing said one or more payment systems groups by said one or more applications;
wherein said prioritizing step of said one or more payment systems groups are based upon one or more parameters;
populating at least one of said one or more payment systems groups with said one or more payment systems based upon said one or more parameters of said user, such that at least one populated payment systems group is created;
sorting said one or more payment systems within said at least one populated payment systems group to create at least one sorted payment systems group;
wherein said sorting step is based upon one or more sorting indicators, a group index value, and a payment systems index value;
wherein said group index value is a priority value assigned to each of said one or more payment systems groups;
wherein said payment systems index value is a weighted value assigned to said one or more sorting indicators;
adding said at least one sorted payment systems group to a list; and
displaying said list in said at least one display screen of said electronic data processing unit.

12. The computer-based method of claim 11, wherein said one or more payment systems groups comprises a first payment systems group; and
wherein said one or more parameters of said first payment systems group comprises a project, a nickname, and email.

13. The computer-based method of claim 12, wherein said one or more payment systems groups further comprises a second payment systems group;
wherein said second payment systems group is ranked lower than said first payment systems group; and
wherein said one or more parameters of said second payment systems group comprises email.

14. The computer-based method of claim 13, wherein said one or more payment systems groups further comprises a third payment systems group;
wherein said third payment systems group is ranked lower than said second payment systems group; and
wherein said one or more parameters of said third payment systems group comprises said project and an internet protocol address.

15. The computer-based method of claim 14, wherein said one or more payment systems groups further comprises a fourth payment systems group;
wherein said fourth payment systems group is ranked lower than said third payment systems group; and
wherein said one or more parameters of said fourth payment systems group comprises said project and said internet protocol address.

16. The computer-based method of claim 15, wherein said one or more payment systems groups further comprises a fifth payment systems group;
wherein said fifth payment systems group is ranked lower than said fourth payment systems group; and
wherein said one or more parameters of said fifth payment systems group comprises said project.

17. The computer-based method of claim 16, wherein said one or more payment systems groups further comprises a sixth payment systems group;
wherein said sixth payment systems group is ranked lower than said fifth payment systems group; and
wherein said one or more parameters of said sixth payment systems group comprises said internet protocol address.

18. The computer-based method of claim 17, wherein said one or more payment systems groups further comprises a seventh payment systems group;
wherein said seventh payment systems group is ranked lower than said sixth payment systems group; and
wherein said one or more parameters of said seventh payment systems group is said internet protocol address.

19. The computer-based method of claim 11, further comprising the step of:
providing a least priority payment systems group;
wherein said least priority payment systems group is ranked lower than said other one or more payment systems groups; and
wherein said least priority payment systems group lacks said one or more parameters.

20. A computer-based method for sorting payment systems, the steps comprising:
providing one or more applications that are configured to run on an electronic data processing unit;
wherein said electronic data processing unit comprises at least one display screen;
providing one or more payment systems by said one or more applications;
receiving one or more parameters of a user by said one or more applications;
providing one or more payment systems groups by said one or more applications;
wherein said one or more payment systems groups comprises a first payment systems group;
wherein said one or more parameters of said first payment systems group comprises a project, a nickname, and email;
wherein said one or more payment systems groups further comprises a second payment systems group;
wherein said second payment systems group is ranked lower than said first payment systems group;
wherein said one or more parameters of said second payment systems group comprises email;
wherein said one or more payment systems groups further comprises a third payment systems group;
wherein said third payment systems group is ranked lower than said second payment systems group;
wherein said one or more parameters of said third payment systems group comprises said project and an internet protocol address;
wherein said one or more payment systems groups further comprises a fourth payment systems group;
wherein said fourth payment systems group is ranked lower than said third payment systems group;
wherein said one or more parameters of said fourth payment systems group comprises said project and said internet protocol address;
wherein said one or more payment systems groups further comprises a fifth payment systems group;
wherein said fifth payment systems group is ranked lower than said fourth payment systems group;
wherein said one or more parameters of said fifth payment systems group comprises said project;
wherein said one or more payment systems groups further comprises a sixth payment systems group;
wherein said sixth payment systems group is ranked lower than said fifth payment systems group;
wherein said one or more parameters of said sixth payment systems group comprises said internet protocol address;
wherein said one or more payment systems groups further comprises a seventh payment systems group;
wherein said seventh payment systems group is ranked lower than said sixth payment systems group;
wherein said one or more parameters of said seventh payment systems group comprises said internet protocol address;
providing a least priority payment systems group;
wherein said least priority payment systems group is ranked lower than said other one or more payment systems groups;
wherein said least priority payment systems group lacks said one or more parameters;
prioritizing said one or more payment systems groups and said least priority payment systems group by said one or more applications;
wherein said prioritizing step of said one or more payment systems groups is based upon one or more parameters;
populating at least one of said one or more payment systems groups with said one or more payment systems based upon said one or more parameters;
sorting said one or more payment systems within said at least one of said one or more populated payment systems groups to create at least one sorted payment systems group;
wherein said sorting step is based upon one or more sorting indicators, a group index value, and a payment systems index value;
wherein said group index value is a priority value assigned to each of said one or more payment systems groups;
wherein said payment systems index value is a weighted value assigned to said one or more sorting indicators;
adding said sorted payment systems group to a list; and
displaying said list in said at least one display screen of said electronic data processing unit.
